(19) United States
(12) Patent Application Publication
(10) Pub. No.: US 2017/0113080 A1
(43) Pub. Date: Apr. 27, 2017

(54) FIRE PREVENTION OR FIRE EXTINGUISHING IN AN ELECTROCHEMICAL ENERGY STORAGE SYSTEM

(71) Applicant: KEY SAFETY SYSTEMS, INC., Sterling Heights, MI (US)

(72) Inventors: Martin Specht, Feldafing (DE); Klaus Meiler, Pocking (DE)

(21) Appl. No.: 15/342,005

(22) Filed: Nov. 2, 2016

Related U.S. Application Data
(63) Continuation-in-part of application No. 14/378,811, filed on Aug. 14, 2014.

(30) Foreign Application Priority Data
Feb. 15, 2012 (DE) 102012003017.7

(51) Int. Cl. A62C 3/07; A62D 1/00; B60R 21/0136; A62D 1/06; A62C 3/16; A62C 37/36

(52) U.S. Cl. CPC A62C 3/07; A62C 3/16; A62C 37/28; B60R 21/0136; A62D 1/06; A62D 1/0014

(57) ABSTRACT

A device for preventing or extinguishing a fire in an electrochemical energy storage system comprising storage cells arranged in a storage housing, wherein the energy storage system is connected to a discharge unit for discharging energy from the energy storage system, the discharge unit comprising: at least one anchor, and a drive assembly for driving the at least one anchor to the ground, the anchor being electrically connected to the energy storage system, such when the anchor is driven to the ground, the energy storage system is grounded.

### FIELD OF THE INVENTION

This patent application claims priority of U.S. Ser. No. 14/378,811, filed Aug. 14, 2014. The invention relates to fire prevention or fire extinguishing in an electrochemical energy storage system comprising storage cells arranged in a storage housing, in particular in lithium-ion cells.

### BACKGROUND AND SUMMARY OF THE INVENTION

Such energy storage systems are used, for example, in the form of “lithium batteries” in the automotive field as energy storage systems for powering electromotive drive units in motor vehicles. Such energy storage systems may generally be used to supply power to electrically driven devices, in particular to electromotive drives. In systems of this kind, a plurality of lithium-ion cells (for example 130 or more) in flat foil packages are grouped in blocks to form storage modules which are disposed in module housings. Like conventional batteries, each storage module has two connection terminals. Grouping cylindrical lithium-ion cells made of tightly wound layers to form a storage module is also known from the prior art.

A plurality of electrically interconnected storage modules forms the energy storage system which delivers, as a “battery”, the electrical energy for powering the electromotive drive units of motor vehicles.

Thermal runaway and overheating may occur due to battery failure, for example after an accident, in particular due to internal short-circuiting. In many cases, the resultant fire hazard is not immediately discernible and may lead to a fire arising after a substantial delay of up to several days or weeks. As lithium is a highly reactive metal, conventional extinguishing agents cannot be used to extinguish such fires. Using an aqueous solution of calcium (Ca) salts and a fire extinguishing gel for fighting fires in lithium-ion battery cells is known from DE 10 2009 035 908 A1.

The object of the invention is to specify measures which can be applied efficaciously to prevent or extinguish a fire in an electromotive storage system containing lithium-ion cells, in particular.

This object is achieved by the features specified in claim 1. The dependent claims contain advantageous developments of the invention.

According to the invention, the energy storage system is connected to a discharge unit for discharging energy from the energy storage system, the discharge unit comprising at least one anchor, and a drive assembly for driving the at least one anchor to the ground, the anchor being electrically connected to the energy storage system, such when the anchor is driven to the ground, the energy storage system is grounded. The invention is based on the idea that in a crash situation it is beneficial to discharge as much energy from the energy storage system as possible. The energy storage system, in a crash situation, forms a high risk for rescue personnel, which might come into contact with the energy storage system. Moreover, as much energy as possible is discharged from the energy storage system, also the likelihood of a fire event or explosion is lowered. The invention involves an anchor and a drive assembly, which drives the anchor, wherein the anchor grounds the energy storage system. In embodiments of the invention, the drive assembly may comprise a pyrotechnical drive cartridge. In further embodiments, the drive assembly may be connected to a vehicle control system and adapted to drive the anchor to the ground when a crash signal is received at the drive assembly.

The crash signal may be provided by a crash sensor, a pre-crash sensor or other elements and devices in the respective car. For example, the crash signal is a delayed airbag signal. The airbag signal is a signal for inflating one or more airbags. Airbags are normally ignited shortly before a crash. The drive assembly for driving the at least one anchor to the ground is preferably activated after the crash, more preferably, when the vehicle has already stopped to move. Therefore, for example, the airbag signal may be delayed, preferably under usage of one or more accelerometers, provided in the vehicle.

In further embodiments, the drive assembly is adapted to drive the anchor into the ground. The anchor is actually wedged into the ground and provides a connection with the ground. The anchor does not only lie on the ground, but is shot or drilled into the ground to even increase the grounding connection of the energy storage unit and the ground.

In a second aspect of the invention, in order to prevent or extinguish a fire in an electrochemical energy storage system, a composition of expandable volume is disposed with limited volume in one or a plurality of hollow spaces inside the storage housing or outside the storage housing. The expandable composition contains an extinguishing agent, in particular chemical compounds and/or a mineral or vitreous granulate, for preventing or extinguishing a fire. The expandable composition may also be prepared in such a way that it is suitable for preventing or extinguishing a fire in the energy storage system, in particular in the storage cells. A sensor unit, which detects any damage or destruction of the electrochemical energy storage system or its storage housing, for example, may be provided to activate expansion of the expandable composition such that the composition or the extinguishing agent contained therein for preventing or extinguishing a fire is brought to the respective critical location on or in the electrochemical energy storage system. The sensor unit may also be embodied in such a way that it detects any excessive acceleration or braking force, as may occur in an accident, for example, and then initiates activation of the expansion of the expandable composition.

Activation of expansion, for example by an electrical signal, may also be produced as the result of an algorithm with which the various signals from sensors in and around the vehicle are analysed. More specifically, what is analysed are signals such as those resulting from acceleration or braking forces acting on the vehicle or regions of the vehicle, for example from impacts or from stresses and strains arising in crash situations.

In the case of a pre-crash signal, the battery storage level can likewise be fetched by query, and expansion of the composition activated if necessary.

In order to activate expansion by means of sensors, the expandable composition may be embodied in a temperature-sensitive form such that expansion of the composition is activated at a particular minimum temperature. It is also possible for the sensor unit to generate an electrical signal with which expansion of the expandable composition is initiated.

Expandable compositions may be advantageously assigned to storage modules of the energy storage system, said storage modules comprising respective pluralities of storage cells. This ensures that, at the respective storage module involved, the risk of fire is eliminated, or that the fire itself is extinguished. To that end, the expandable composition may be disposed inside or also outside the housing of a respective storage module.

A discharge unit may be advantageously provided on the energy storage system, or the energy storage system may be connected to a discharge unit, wherein the discharge energy of the discharge unit can be used to accelerate expansion of the composition. The discharge energy may also be used to activate expansion of the composition. In order to dispose the expandable composition in a limited volume, it may be disposed in one or more containers. It is also possible to provide the expandable composition as a coating containing the at least one fire-preventing or fire-extinguishing extinguishing agent in powder form, for example in a coating of paint.

It is also possible to provide the expandable composition as a shaped body, for example in tablet form.

The expandable composition may also include a dry propellant which preferably forms nitrogen when it expands. Examples of suitable propellants include sodium azide (NaN₃), guanidine nitrate or aminotetrazole compounds. One such propellant for filling airbags, for example, is known from the prior art. When the propellant provided in dried form is activated, it expands in gaseous form and cause the at least one extinguishing agent for preventing or extinguishing a fire to the respective critical location in the energy storage system.

The expandable composition may also include at least one gas or gas mixture held under pressure in one or more containers. The gas or gas mixture consists wholly or partially of inert gas, for example of argon and/or helium, and a gas mixture may comprise argon (98%) and helium (2%), for example. The gas or gas mixture may be held in readiness in a pressure vessel, together with the at least one extinguishing agent for preventing or extinguishing a fire. However, it is also possible to keep the gas or gas mixture in a separate container and to guide it on expansion into the container in which the extinguishing agent is located.

The arrangement may be provided in a hybrid gas generator for filling an airbag, for example, i.e. the pressurised gas and the extinguishing agent can be mixed in a compressed gas tank. The mixture of the pressurised gas and the extinguishing agent may then be brought rapidly to the respective location in order to prevent or extinguish any fire in the battery.

In order to prevent a fire, the expandable compositions may include at least one substance as extinguishing agent, which stops any uncontrolled chemical reaction, in particular any exothermic reaction, in a respective storage cell. The expandable compositions may also include at least one substance which can form a barrier between the anode and the cathode of a respective storage cell, in particular when the separator or the electrolyte is destroyed. The substance may be a resin-forming substance, for example. This resin-forming substance may deposit itself on the electrode surfaces, for example, thus preventing any short circuits inside the cell.

In the invention, at least one aerosol-forming extinguishing agent may be used as an expandable composition or in the expandable composition to extinguish a fire. In the electrochemical energy storage system, this extinguishing agent is provided in or on the storage housing. The extinguishing agent may be disposed for this purpose in one or more hollow spaces inside the storage housing. The extinguishing agent may also be provided in one or more containers disposed on the outside of the storage housing. The aerosol-forming extinguishing agent is embodied in such a way that it can be activated at a specified minimum temperature above the operating temperature of the energy storage system, for example at 150° C. or higher, or by an electrical signal. The electrical signal can be generated by a temperature sensor disposed in the storage housing.

Due to the rapid expansion of the extinguishing agent when forming aerosol, for example, the extinguishing agent may be disposed in small containers inside the housing that surrounds the energy storage system, in particular the battery system. The extinguishing agent may also be accommodated in each of the housings provided for the storage modules. In this way, local seats of fire can be extinguished rapidly and efficaciously. If the containers for extinguishing agent are disposed on the outside of the storage housing, the extinguishing agent is likewise brought to the seat of the fire inside the housing due to its rapid expansion.

A distribution system may be provided, for example in the housing wall, or a system of piping with valve inlets may be provided in the modules, in order to bring the chemical compound for preventing or extinguishing a fire to the respective critical location in or on the energy storage system.

An aerosol-forming composition, for example, contains microparticles which may be suspended in an inert gas. The ratio of exposed surface area to mass is relatively high, so the amount of active material required to extinguish a fire can be kept to a minimum. The microparticles remain suspended in the gas for a relatively long time, so they can penetrate the natural convection flows that exist when combustion occurs. The composition may be provided in unpressurised form in a container, or in pressurised form in a pressure vessel.

In the case of an aerosol-forming composition, a substance is preferably used which forms a solid aerosol that is transformed upon activation into a rapidly expanding aerosol based on potassium compounds, for example. This composition may be disposed in one or more unpressurised containers for extinguishing agent, preferably inside the storage housing. For this purpose, the composition may be provided in one or more hollow spaces inside the storage housing. The composition is preferably assigned to respective storage modules, the composition preferably being disposed inside the respective storage module housing. The composition may also be provided as a coating, or in the form of tablets or pellets.

A discharge unit which supplies discharge energy for distributing the fire-extinguishing aerosol when extinguishing a fire may preferably be provided on the energy storage system.

Fire extinguishing using extinguishing agents that contain potassium compounds is based on the fact that any potassium which is released in a fire by the decomposition of the potassium compounds will react with free radicals produced during combustion to form potassium hydroxide, which is a very stable compound. The chain reaction of the free radicals produced during combustion is stopped as a result and the fire is extinguished.

Such aerosol-forming compositions are used in fire extinguishers for fighting fires in enclosed spaces. The fire extinguishers and fire extinguishing systems are commercially obtainable as Fire Pro® and Stat-X®.

In DE 196 34 006 C2, there is also described a suitable aerosol-forming composition which contains the following, in mass percent:

| | |
|---|---|
| Potassium nitrate | 67-72 |
| Dicyanodiamide | 9-16 |
| Phenol formaldehyde resin | 8-12 |
| Potassium benzoate, bicarbonate or hexacyanoferrate | 4-12. |

In this case, dicyanodiamide is the gas-aerosol-forming substance.

The expandable composition containing the extinguishing agent for preventing or extinguishing a fire may preferably be disposed in such a way that expansion of the composition can be activated twice or more times in succession. In this way, any subsequent fire that may arise after extinguishing a fire can again be extinguished. To that end, the expandable composition may be disposed in two or more units which can be successively activated. This plurality of units may be provided in one or more respective containers.

The extinguishing agent which is used to prevent or extinguish a fire may also include a mineral or vitreous granulate. This granulate may form the extinguishing agent on its own or in combination with a chemical substance used for preventing or extinguishing a fire, for example the potassium compound as described above. The granulate preferably has a grain size of less than 0.5 mm. Even more preferably, the granulate has a grain size of less than 0.2 mm. The granulate may be provided in the form of hollow microspheres. Production of such a granulate is known from EP 1 832 560 A2, for example.

### BRIEF DESCRIPTION OF THE DRAWINGS

FIG. 1 is a schematic view of an electrochemical energy storage system;

FIG. 2 is a schematic view of a vehicle including a device for preventing or extinguishing a fire;

FIG. 3 is a schematic view of a device for preventing fire; and

FIGS. 4a and 4b show an example of a drive assembly.

### DETAILED DESCRIPTION OF THE DRAWINGS

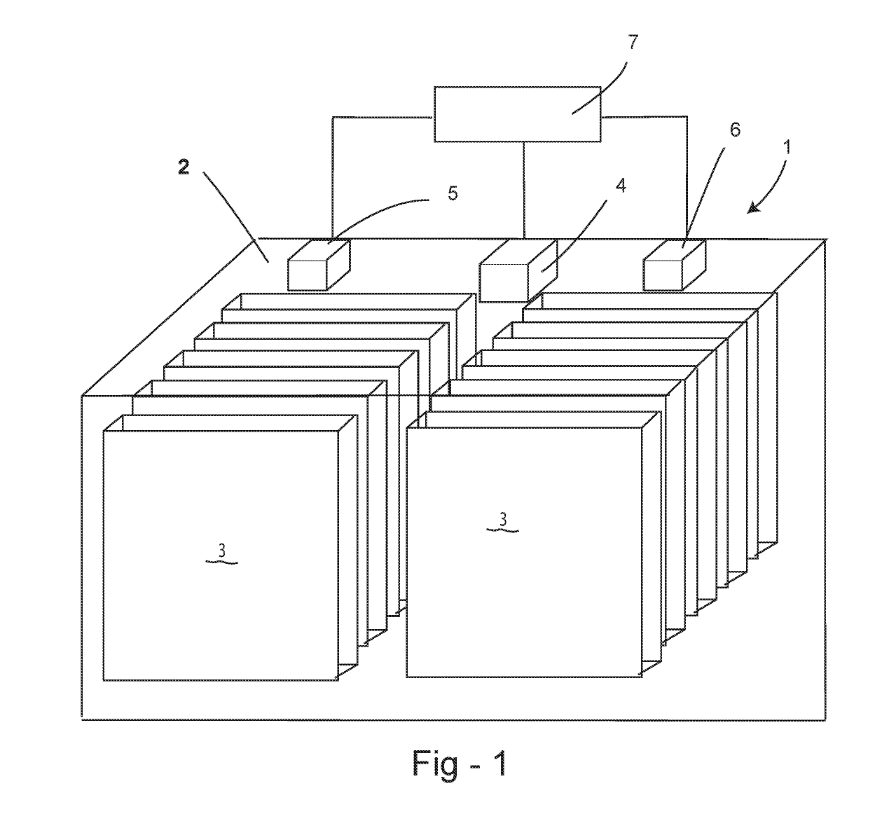

The attached FIG. 1 shows an electrochemical energy storage system 1, which can be a battery for a vehicle, in particular for a motor vehicle. However, it may also be a battery which is deployed in a stationary manner. Storage cells 3 are arranged in a storage housing 2 of energy storage system 1. The cells may be lithium-ion cells, for example. Inside the housing, a container 4 is disposed in which a composition of expandable volume, preferably in a compact form, is held in readiness. This composition may be an extinguishing agent for preventing or extinguishing a fire. It may be a chemical substance which is used to prevent or extinguish the fire. The extinguishing agent for preventing or extinguishing the fire is distributed inside storage housing 2 by means of a propellant. However, it is also possible to provide a container 4 containing the expandable composition for each storage cell 3, or for each pack consisting of a plurality of storage cells 3. Container 4 may also be disposed on the outside of storage housing 2.

As an extinguishing agent, the expandable composition inside housing 4 may also include a mineral or vitreous granulate. Not only the mineral or vitreous granulate, but also the chemical substance used to prevent or extinguish the fire may be used for the extinguishing agent.

Expansion of the volume of the composition provided in container 4 can be activated by sensors. One or more sensors may be provided for that purpose. For example, one or more temperature sensors 5 and/or one or more acceleration sensors 6 may be provided. In this way, it is possible to detect any excessive temperature in storage housing 2. It is also possible to detect any excessive braking or acceleration force, in particular any damage caused to energy storage system 1 or to storage cells 3. Sensors 5, 6 are connected to an analyser/controller 7, which can be an electronic computer device, for example the on-board computer in a vehicle. In analyser/controller 7, the signals from the sensors are analysed with regard to the prevention or extinguishing of a fire in or on energy storage system 1, and the respective control signals for initiating expansion of the volume of the composition kept in container 4 are supplied accordingly.

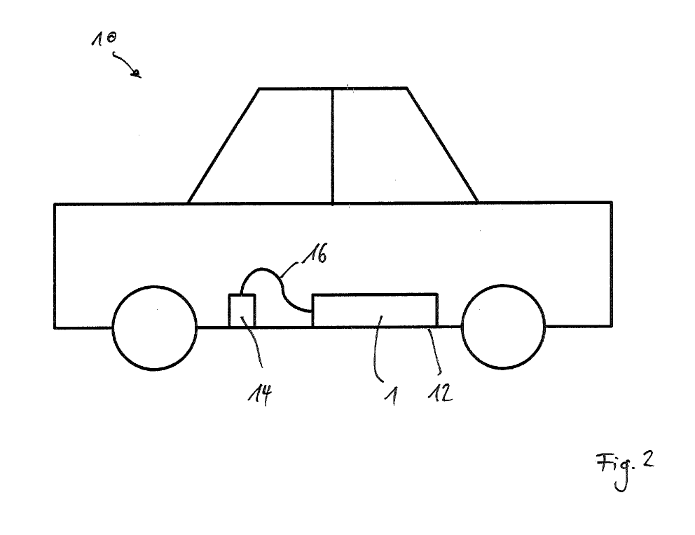

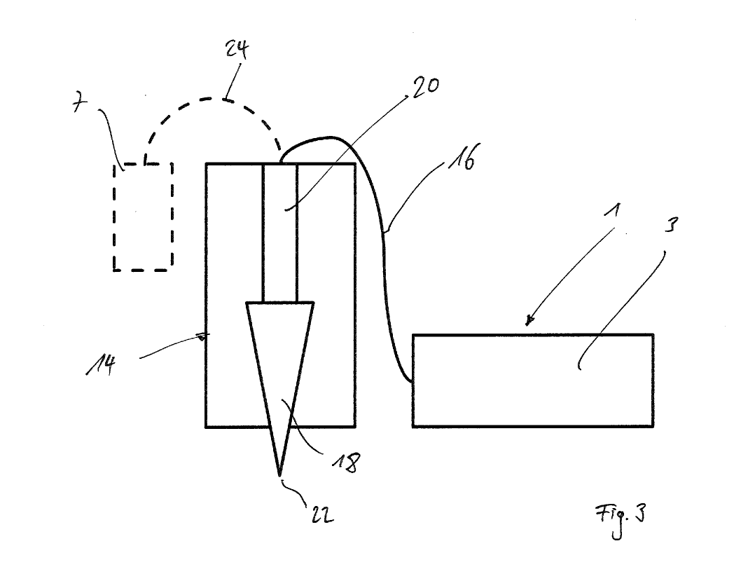

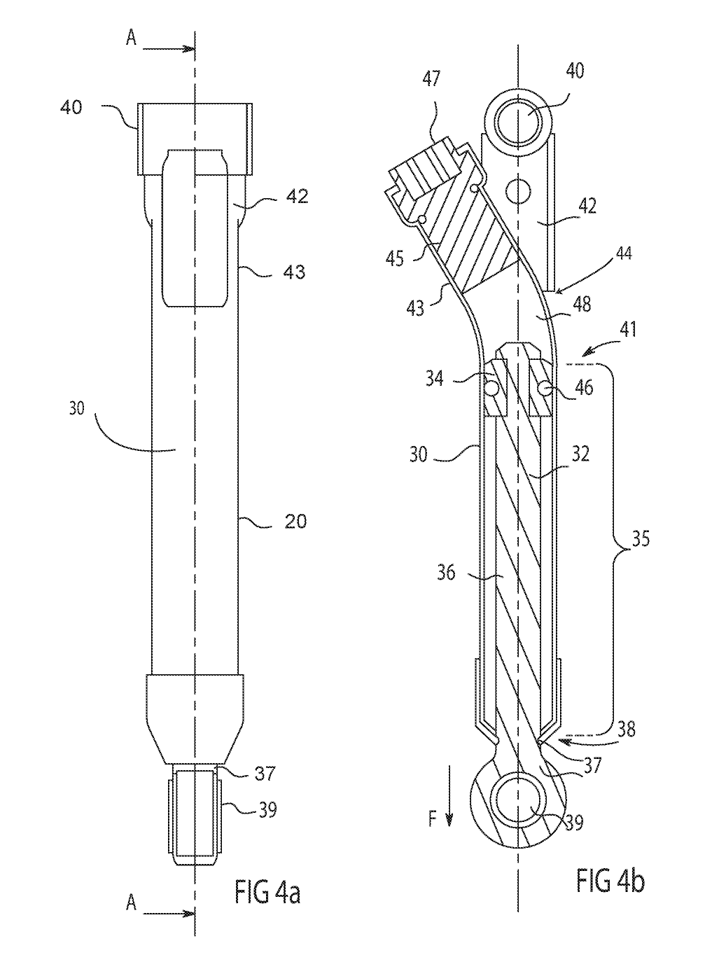

FIG. 2 illustrates a vehicle 10 comprising an energy storage system 1 mounted in a floor area 12 of the vehicle. In this embodiment, the energy storage system 1 is connected to a discharge unit 14 via a cable 16. The discharge unit is adapted to discharge energy from the energy storage system 1 and will be described in more detail with reference to FIGS. 3 and 4.

As shown in FIG. 3, the discharge unit 14 comprises one anchor 16, 18 and a drive assembly 20 (which will be described in further detail with FIG. 4). The drive assembly 20 is adapted to drive the anchor 18 towards the ground and thus, out of the bottom 12 of the vehicle 10. The Anchor 18 is connected to the wire 16 and the wire 16 has a length, such that anchor 18 can reach the ground and preferably that the vehicle 10 can move after the anchor 18 has engaged the ground. In this embodiment, the anchor 18 is adapted to be moved into the ground and therefore it comprises a sharp edge 22, which might be formed based on ballistic design rules. Anchor 18 is made out of metal, such that it can conduct electrical energy. Wire 16 is designed with a relatively large diameter so that as much current as possible may flow from the energy storage device 1 through cable 16 into anchor 18 and from anchor 18 to the ground. Due to the discharge of the energy storage device 1, the tendency for a fire or explosion is lowered.

The drive assembly 20 is connected to the analyzer/controller 7 via a respective signal line 24. The analyzer/controller 7 may be connected to the vehicle control unit. Alternatively, the drive assembly 20 is directly connected to the vehicle control unit. The drive assembly 20 receives a signal from analyzer/controller 7 via signal line 24 to drive the anchor 18 to the ground.

In this embodiment, the drive assembly 20 is a pyrotechnical drive, shown in FIGS. 4a and 4b. While FIG. 4a is a side view of the drive assembly, FIG. 4b is a cut along line A-A according to FIG. 4a. Drive assembly 20 has a pressure pipe 30 having a pipe access 32, in which a piston 34, which can be driven by a drive gas, can be moved along a linear guideway 35. A piston rod 36 extends along the linear guideway 3 inside the pressure pipe 30 and is securely connected to the piston 34. The piston 34 and piston rod 36 may be two parts, or formed as one piece. A rod portion 37 of piston rod 36 projects beyond a first pressure pipe end, in particular at first guideway end 38. A connection point 39 at which the piston rod can be connected to the anchor 18, or a mounting assembly of the anchor 18 is provided on said rod portion 36. As shown in FIGS. 4a and 4b, connection point 39 may be in the form of a log for receiving a part of the anchor 18. However, preferably, the connection point 39 is only detachably mounted to anchor 18, so that anchor 18 can be released from rod 39. To release anchor 18 from rod 39, anchor 18 may be connected to connection point 39 by means of a breakable element, as e.g. a plastic element with a breakpoint.

A second connection point 40 is provided on the pressure pipe 30 at the second guideway end 41. This second connection point 40 is designed for supporting the drive assembly 20 at the vehicle body. As shown in the FIGS. 4a and 4b, the second connection point 40 may likewise be in the form of a log, which can force-lockingly receive a support member of the vehicle body.

The second connection point 20 can be securely connected by a fitting part 42 to pressure pipe 30. Connection point 39 and 40 are arranged in such a way that they are aligned with the linear extension of guideway 35 of pressure pipe 30. However, the second connection point 20 may also be attached in the intermediate vicinity of the angled pressure pipe portion 43. It is preferably attached by welding, in particular by but welding, to the welding portion 44 in the region of the angled pressure pipe portion 43.

A drive gas is supplied by a gas source 45 to drive piston 34 along linear guideway 3. Piston 34 contacts the inner surface of pressure pipe 30 tightly, by means of a sealing ring 46, for example, by means of an O-ring. Gas source 45 is located in a pressure pipe portion 43, which is angled at an angle to the linear guideway 3 of pressure pipe 30; the interior of angled pressure pipe portion 43 continuous into the interior of linear guideway 3. The drive gas produced by gas source 8 acts on the rear side of piston 34 and moves the latter along guideway 3 in pressure pipe 30.

Piston 34 and piston rod 36 are preferably made of metal or any conducting material. Alternatively it may be made of a fiber/plastic composing material, in particular of glass, fiber/plastic composing material, in particular of glass, fiber/plastic composing material. There might be an additional wire for providing a conducing connection when needed. Pressure pipe 30 is preferably made of stainless steel.

Gas source 45 is preferably embodied as an electrically ignitable gas generator, in particular as a pyrotechnical gas generator. The gas generator is inserted tightly into the end of the angled pressure pipe portion 43. At its free end, there is an electrical plug connection part 47, to which signal line 24 (see FIG. 3) might be connected. By means of igniting the gas source 45, gas is introduced into the pressure pipe 30 at portion 48, such that connector 39 is moved downwards and drives anchor 18 to the ground.

Many changes and modifications in the above-described embodiment of the invention can, of course, be carried out without departing from the scope thereof. Accordingly, that scope is intended to be limited only by the scope of the appended claims.

1. A device for preventing or extinguishing a fire in an electrochemical energy storage system comprising storage cells arranged in a storage housing, wherein
the energy storage system is connected to a discharge unit for discharging energy from the energy storage system, the discharge unit comprising:
at least one anchor, and
a drive assembly for driving the at least one anchor to the ground,
the anchor being electrically connected to the energy storage system, such when the anchor is driven to the ground, the energy storage system is grounded.

2. The device according to claim 1, wherein the drive assembly comprises a pyrotechnical drive cartridge.

3. The device according to claim 1, wherein the drive assembly is connected to a vehicle control system and adapted to drive the anchor to the ground when a crash signal is received at the drive assembly.

4. The device according to claim 3, wherein the crash signal is a delayed air-bag signal.

5. The device according to claim 1, wherein the drive assembly is adapted to drive the anchor into the ground.

6. The device according to claim 1, further including a composition of expandable volume, containing an extinguishing agent for preventing or extinguishing a fire, is disposed with limited volume in one or a plurality of hollow spaces in or on the storage housing, wherein expansion of the volume of the composition can be activated by sensors.

7. The device according to claim 6, wherein expandable compositions are assigned to storage modules of the energy storage system, said storage modules comprising respective pluralities of storage cells.

8. The device according to claim 6, wherein the expandable composition is disposed inside the housing of a respective storage module.

9. The device according to claim 6, wherein at least a part of the discharged energy of the discharge unit is used for expanding the composition.

10. The device according to claim 6, wherein the expandable composition is disposed in one or more containers.

11. The device according to claim 6, wherein the expandable composition is provided as a coating.

12. The device according to claim 6, wherein the expandable compositions is provided as a shaped body.

13. The device according to claim 6, wherein the expandable composition is an aerosol-forming composition.

14. The device according to claim 6, wherein the extinguishing agent for preventing or extinguishing a fire includes a chemical compound which reacts with radicals released by the fire to form at least one stable compound.

15. The device according to claim 6, wherein the expandable composition includes at least one alkali metal compound, in particular a potassium compound.

16. The device according to claim 6, wherein the expandable composition includes potassium nitrate.

17. The device according to claim 6, wherein the extinguishing agent for preventing or extinguishing a fire includes a mineral or vitreous granulate.

18. The device according to claim 17, wherein the granulate has a grain size of less than 0.5 mm.

19. The device according to claim 6, wherein the expandable composition includes a dry propellant.

20. The device according to claim 19, wherein the propellant forms nitrogen when it expands.

21. The device according to claim 6, wherein the expanded composition includes a gas or gas mixture held under pressure in a container.

22. An electrochemical energy storage system provided with the device according to claim 1.

23. The storage system according to claim 22, comprising a sensor unit being sensitive to an excessive acceleration or braking force acting on the electrochemical storage system, or sensitive to any damage occurring in or caused to the electrochemical storage system.

24. The device according to claim 1, comprising an expandable component, comprising one or more of the following components:
at least one substance preventing an uncontrolled chemical reaction in a respective storage cell;
at least one substance extinguishing a fire in the energy storage system;
at least one substance forming a barrier between the anode and the cathode of a respective storage cell;
at least one aerosol-forming substance;
at least one dry propellant which can be converted by activation to a gaseous form;
at least one gas or gas mixture which is held under pressure.

25. The device according to claim 24, wherein the fire-extinguishing substance includes at least one potassium compound which decomposes during combustion to release potassium, which reacts with free radicals produced during combustion to form stable potassium hydroxide, and/or includes a mineral or vitreous granulate.

26. The device according to claim 24 characterised by an arrangement which activates expansion of the composition two or more times.
